(19) United States
(12) Patent Application Publication
(10) Pub. No.: US 2019/0160867 A1
(43) Pub. Date: May 30, 2019

(54) Hollow Caster Structure

(71) Applicant: Shuen Hsuan Wang, Yuanli Jen (TW)

(72) Inventor: Shuen Hsuan Wang, Yuanli Jen (TW)

(21) Appl. No.: 15/821,890

(22) Filed: Nov. 24, 2017

(51) Int. Cl. B60B 33/00; B60B 33/04

(52) U.S. Cl. CPC B60B 33/0028; B60B 33/0042; B60B 33/0068; B60B 33/0057; B60B 2380/12; B60B 33/0073; B60B 2900/111; B60B 2900/572; B60B 2900/313; B60B 33/045

(57) ABSTRACT

A hollow caster structure includes a base, a caster body pivotally connected with the base, a first wheel unit mounted on the caster body, and a second wheel unit mounted on the caster body. Each of the first wheel unit and the second wheel unit forms a viewing space. Thus, the viewing space of each of the first wheel unit and the second wheel unit provides a visible effect. In addition, the hollow caster structure has a lighter weight by provision of the viewing space. Further, the parts of the hollow caster structure have different colors which are visible from the viewing space.

### BACKGROUND OF THE INVENTION

### 1. Field of the Invention

The present invention relates to a caster and, more particularly, to a hollow caster structure for a luggage, baggage carrier, baby stroller, chair or the like.

### 2. Description of the Related Art

A conventional caster in accordance with the prior art shown in FIG. 1 comprises a base 11 having a mounting hole 12, a castor body 13 having an upright 131 pivotally mounted in the mounting hole 12 of the base 11, a spindle 14 extending through the mounting hole 12 of the base 11 and the upright 131 of the castor body 13, two wheels 15 mounted on two sides of the castor body 13 and each having a central hole 151, and a shaft 133 extending through the central hole 151 of each of the two wheels 15 and a shaft hole 132 of the castor body 13. The spindle 14 has an upper end provided with a rivet head 142 riveted in the mounting hole 12 of the base 11. The rivet head 142 of the spindle 14 is provided with a limit flange 141. However, each of the two wheels 15 is centered at and rotated about the central hole 151, and the castor body 13 has to mate with the two wheels 15, so that the volume of the castor body 13 and the two wheels 15 cannot be reduced, and the conventional caster has a heavier weight. In addition, each of the two wheels 15 is made rotatable by being centered at the central hole 151, so that each of the two wheels 15 does not have a space to provide a visible effect.

### BRIEF SUMMARY OF THE INVENTION

The primary objective of the present invention is to provide a hollow caster structure having a different visible effect, having a lighter weight and having a shock-absorbing function.

In accordance with the present invention, there is provided a hollow caster structure comprising a base, a caster body pivotally connected with the base, a first wheel unit mounted on the caster body, and a second wheel unit mounted on the caster body. The base is provided with a mounting portion which has interior provided with a through hole. The caster body is provided with an upright pivotally mounted on a bottom of the mounting portion of the base. The caster body is provided with a transverse hole. The first wheel unit includes a first wheel, a first cap mounted on the first wheel, and a second cap mounted on the first wheel. The first wheel has a first central hole. The first central hole has a first side provided with a first mounting recess and a second side provided with a second mounting recess. The first cap is mounted in the first mounting recess. The first cap has a first viewing hole aligning with the first central hole. The first cap is provided with a first shaft hole which is located at an eccentric position deviating from a central point of the first viewing hole. The second cap is mounted in the second mounting recess. The second cap has a second viewing hole aligning with the first central hole. The second cap is provided with a second shaft hole which is located at an eccentric position deviating from a central point of the second viewing hole. The second wheel unit includes a second wheel, a third cap mounted on the second wheel, and a fourth cap mounted on the second wheel. The second wheel has a second central hole. The second central hole has a first side provided with a third mounting recess and a second side provided with a fourth mounting recess. The third cap is mounted in the third mounting recess. The third cap has a third viewing hole aligning with the second central hole. The third cap is provided with a third shaft hole which is located at an eccentric position deviating from a central point of the third viewing hole. The fourth cap is mounted in the fourth mounting recess. The fourth cap has a fourth viewing hole aligning with the second central hole. The fourth cap is provided with a fourth shaft hole which is located at an eccentric position deviating from a central point of the fourth viewing hole. A shaft extends through the fourth shaft hole of the fourth cap, the third shaft hole of the third cap, the transverse hole of the caster body, the second shaft hole of the second cap and the first shaft hole of the first cap, and a screw member is screwed onto a distal end of the shaft, so that the caster body, the first wheel unit and the second wheel unit are combined together.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of a conventional caster in accordance with the prior art.

FIG. 2 is a perspective view of a hollow caster structure in accordance with the preferred embodiment of the present invention.

FIG. 3 is another perspective view of the hollow caster structure in accordance with the preferred embodiment of the present invention.

FIG. 4 is a partially exploded perspective view of the hollow caster structure as shown in FIG. 2.

FIG. 5 is a perspective view of a caster body of the hollow caster structure in accordance with the preferred embodiment of the present invention.

FIG. 6 is an exploded perspective view of a first wheel unit of the hollow caster structure in accordance with the preferred embodiment of the present invention.

FIG. 7 is another perspective view of a second cap of the first wheel unit as shown in FIG. 6.

FIG. 8 is another perspective view of a first wheel of the first wheel unit as shown in FIG. 6.

FIG. 9 is another perspective view of a first cap of the first wheel unit as shown in FIG. 6.

FIG. 10 is an exploded perspective view of a second wheel unit of the hollow caster structure in accordance with the preferred embodiment of the present invention.

FIG. 11 is another perspective view of a second wheel of the second wheel unit as shown in FIG. 10.

FIG. 12 is another perspective view of a third cap of the second wheel unit as shown in FIG. 10.

FIG. 13 is a cross-sectional view of the hollow caster structure as shown in FIG. 2.

FIG. 14 is a cross-sectional view of the first wheel unit of the hollow caster structure in accordance with the preferred embodiment of the present invention.

FIG. 15 is a cross-sectional view of the second wheel unit of the hollow caster structure in accordance with the preferred embodiment of the present invention.

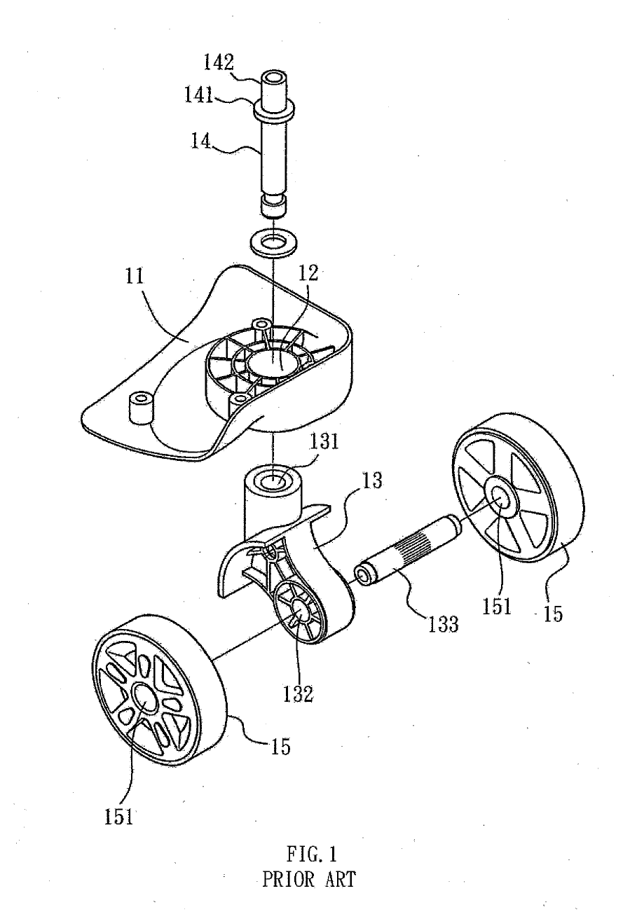

### DETAILED DESCRIPTION OF THE INVENTION

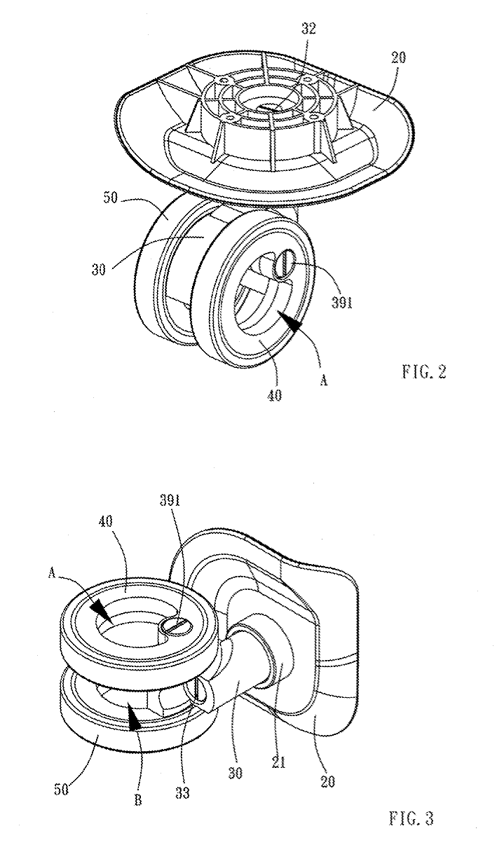

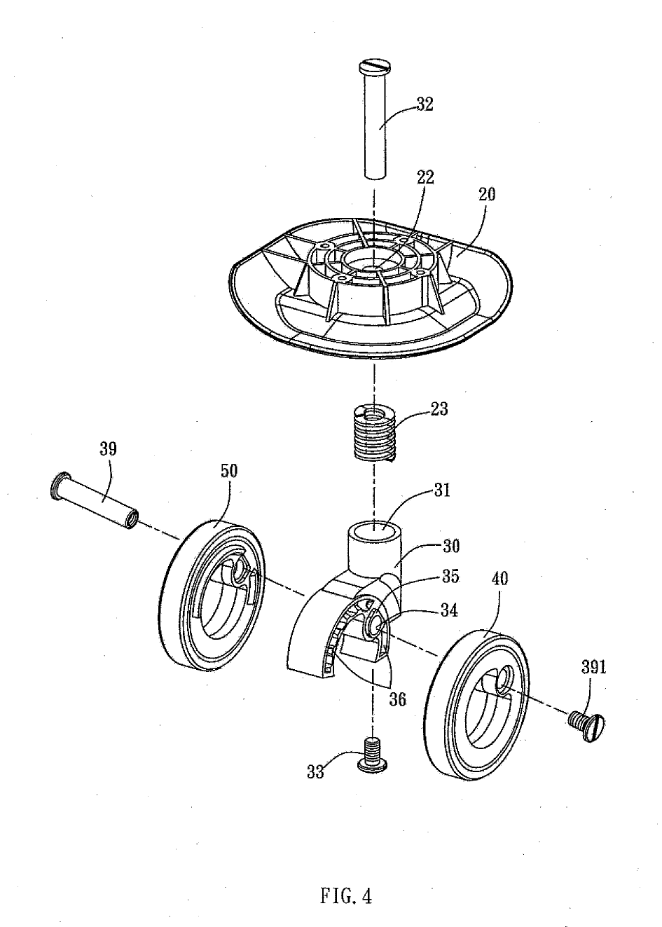

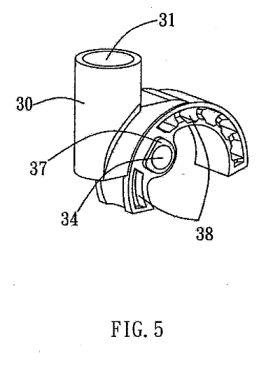

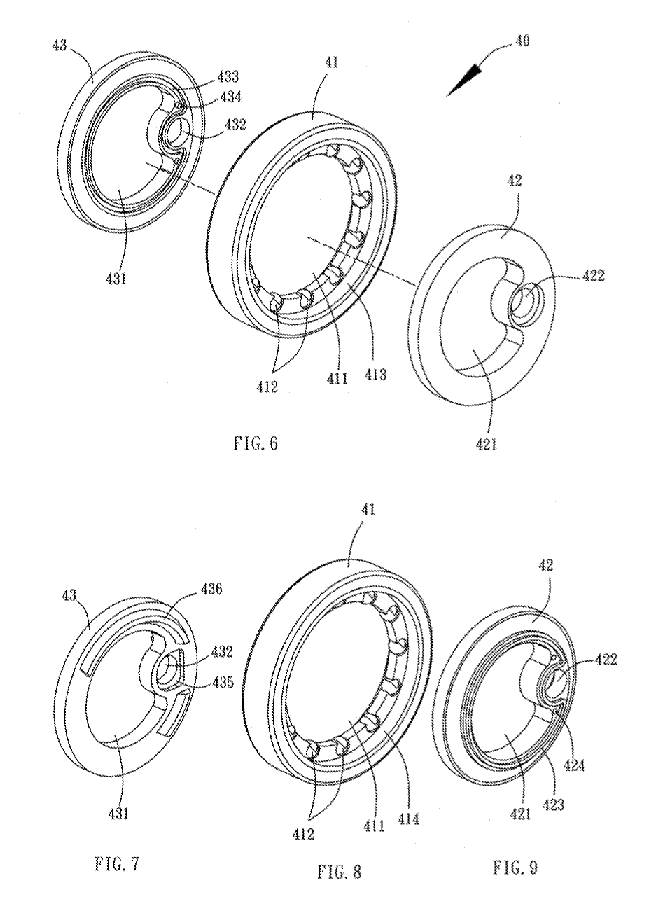

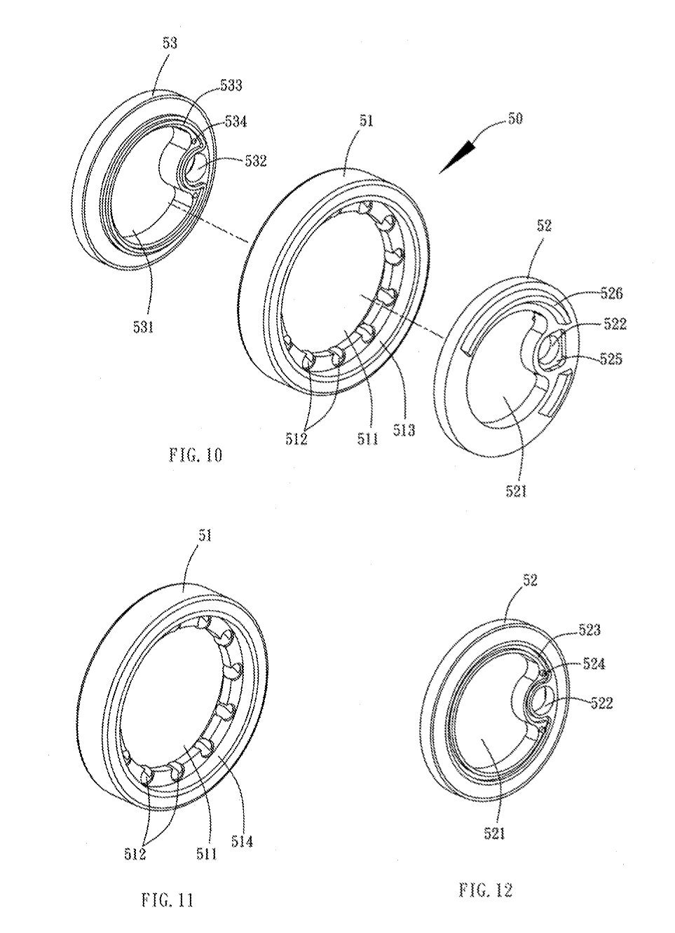

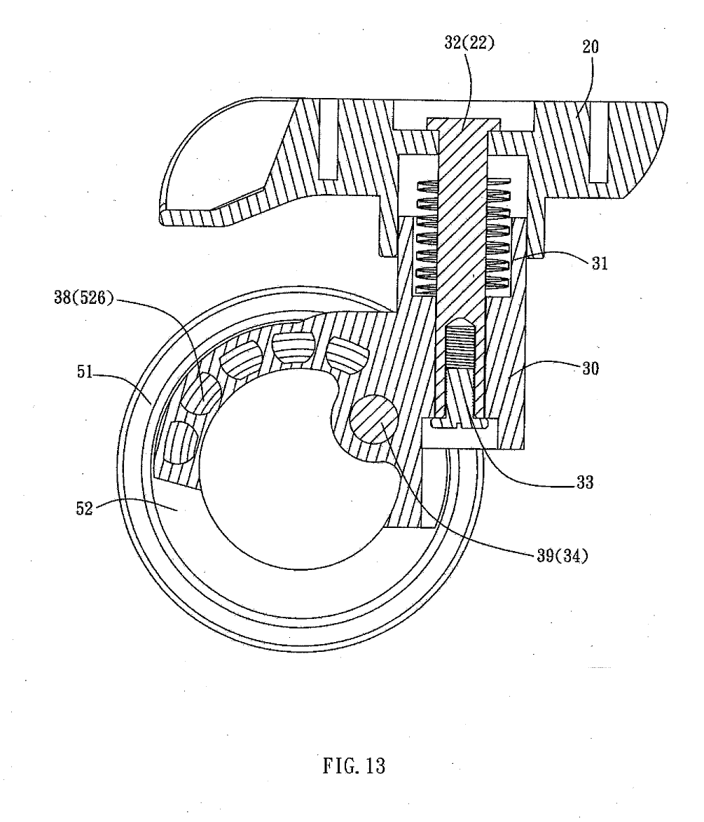

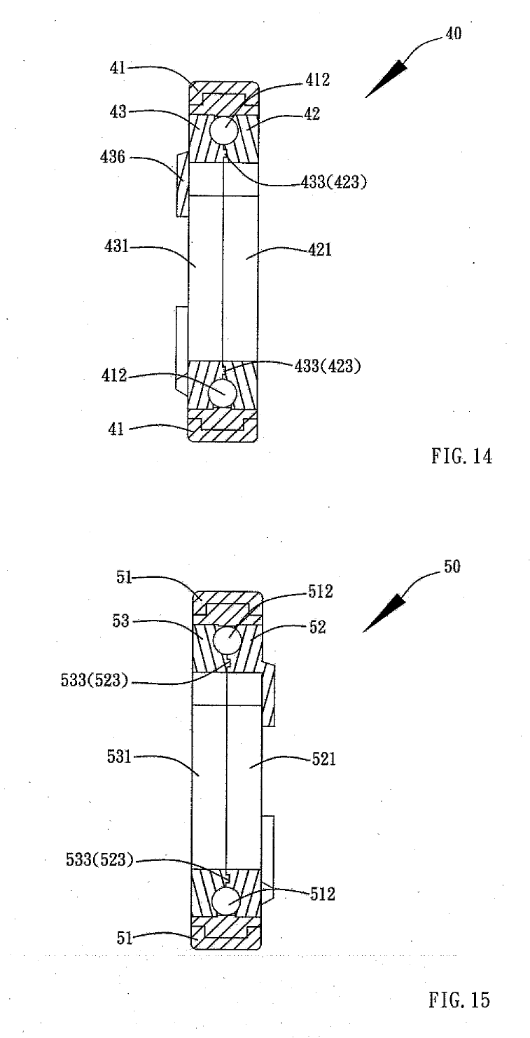

Referring to the drawings and initially to FIGS. 2-15, a hollow caster structure in accordance with the preferred embodiment of the present invention comprises a base 20, a caster body 30 pivotally connected with the base 20, a first wheel unit 40 mounted on the caster body 30, and a second wheel unit 50 mounted on the caster body 30.

The base 20 is provided with a mounting portion 21 which has interior provided with a through hole 22.

The caster body 30 is provided with an upright 31 pivotally mounted on a bottom of the mounting portion 21 of the base 20. The caster body 30 is provided with a transverse hole 34.

The first wheel unit 40 includes a first wheel 41, a first cap 42 mounted on the first wheel 41, and a second cap 43 mounted on the first wheel 41.

The first wheel 41 has a first central hole 411. The first central hole 411 has a first side provided with a first mounting recess 413 and a second side provided with a second mounting recess 414.

The first cap 42 is mounted in the first mounting recess 413. The first cap 42 has a first viewing hole 421 aligning with the first central hole 411. The first cap 42 is provided with a first shaft hole 422 which is located at an eccentric position deviating from a central point of the first viewing hole 421.

The second cap 43 is mounted in the second mounting recess 414. The second cap 43 has a second viewing hole 431 aligning with the first central hole 411. The second cap 43 is provided with a second shaft hole 432 which is located at an eccentric position deviating from a central point of the second viewing hole 431.

The second wheel unit 50 includes a second wheel 51, a third cap 52 mounted on the second wheel 51, and a fourth cap 53 mounted on the second wheel 51.

The second wheel 51 has a second central hole 511. The second central hole 511 has a first side provided with a third mounting recess 513 and a second side provided with a fourth mounting recess 514.

The third cap 52 is mounted in the third mounting recess 513. The third cap 52 has a third viewing hole 521 aligning with the second central hole 511. The third cap 52 is provided with a third shaft hole 522 which is located at an eccentric position deviating from a central point of the third viewing hole 521.

The fourth cap 53 is mounted in the fourth mounting recess 514. The fourth cap 53 has a fourth viewing hole 531 aligning with the second central hole 511. The fourth cap 53 is provided with a fourth shaft hole 532 which is located at an eccentric position deviating from a central point of the fourth viewing hole 531.

In assembly, a shaft 39 in turn extends through the fourth shaft hole 532 of the fourth cap 53, the third shaft hole 522 of the third cap 52, the transverse hole 34 of the caster body 30, the second shaft hole 432 of the second cap 43 and the first shaft hole 422 of the first cap 42, and a screw member 391 is screwed onto a distal end of the shaft 39, so that the caster body 30, the first wheel unit 40 and the second wheel unit 50 are combined together.

In the preferred embodiment of the present invention, the hollow caster structure further comprises an elastic member 23 mounted in the through hole 22 of the base 20 and biased between the base 20 and the upright 31 of the caster body 30, a spindle 32 extending through the through hole 22 of the base 20, the elastic member 23 and the upright 31 of the caster body 30, and a screw element 33 screwed onto a lower end of the spindle 32 and resting on a bottom of the upright 31.

In the preferred embodiment of the present invention, the caster body 30 is provided with a first locking piece 35 and a first locking slot 36, and the second cap 43 is provided with a first retaining piece 436 mounted in the first locking slot 36 of the caster body 30 and a first retaining slot 435 mounted on the first locking piece 35 of the caster body 30, so that the second cap 43 is affixed to the caster body 30.

In the preferred embodiment of the present invention, the caster body 30 is provided with a second locking piece 37 and a second locking slot 38, and the third cap 52 is provided with a second retaining piece 526 mounted in the second locking slot 38 of the caster body 30 and a second retaining slot 525 mounted on the second locking piece 37 of the caster body 30, so that the third cap 52 is affixed to the caster body 30.

In the preferred embodiment of the present invention, the first cap 42 is provided with a first flange 423 and a first cavity 424, and the second cap 43 is provided with a first stub 434 closely fitted into the first cavity 424 of the first cap 42 and a first groove 433 closely fitted onto the first flange 423 of the first cap 42, so that the first cap 42 and the second cap 43 are combined closely.

In the preferred embodiment of the present invention, the fourth cap 53 is provided with a second flange 533 and a second cavity 534, and the third cap 52 is provided with a second stub 524 closely fitted into the second cavity 534 of the fourth cap 53 and a second groove 523 closely fitted onto the second flange 533 of the fourth cap 53, so that the third cap 52 and the fourth cap 53 are combined closely.

In the preferred embodiment of the present invention, the first central hole 411 of the first wheel 41 has an inner peripheral wall provided with a plurality of rolling balls 412 which are arranged in an annular shape and are centered at the first central hole 411. The rolling balls 412 of the first wheel 41 are located between the first cap 42 and the second cap 43 to construct a ball bearing mechanism.

In the preferred embodiment of the present invention, the second central hole 511 of the second wheel 51 has an inner peripheral wall provided with a plurality of rolling balls 512 which are arranged in an annular shape and are centered at the second central hole 511. The rolling balls 512 of the second wheel 51 are located between the third cap 52 and the fourth cap 53 to construct a ball bearing mechanism.

In the preferred embodiment of the present invention, the first viewing hole 421 of the first cap 42, the first central hole 411 of the first wheel 41 and the second viewing hole 431 of the second cap 43 form a viewing space “A” which extends through the first wheel 41.

In the preferred embodiment of the present invention, the third viewing hole 521 of the third cap 52, the second central hole 511 of the second wheel 51 and the fourth viewing hole 531 of the fourth cap 53 form a viewing space “B” which extends through the second wheel 51.

In operation, the second cap 43 is affixed to the caster body 30, while the first cap 42 and the second cap 43 are combined together, so that the first cap 42 and the second cap 43 are restricted by the caster body 30 and cannot be rotated. In such a manner, the rolling balls 412 of the first wheel 41 are located between the first cap 42 and the second cap 43 to construct a ball bearing mechanism, so that the first wheel 41 is rotated relative to the first cap 42 and the second cap 43 by movement of the rolling balls 412 Similarly, the third cap 52 is affixed to the caster body 30, while the third cap 52 and the fourth cap 53 are combined together, so that the third cap 52 and the fourth cap 53 are restricted by the caster body 30 and cannot be rotated. In such a manner, the rolling balls 512 of the second wheel 51 are located between the third cap 52 and the fourth cap 53 to construct a ball bearing mechanism, so that the second wheel 51 is rotated relative to the third cap 52 and the fourth cap 53 by movement of the rolling balls 512.

Accordingly, the viewing space “A” extends through the first wheel 41, and the viewing space “B” extends through the second wheel 51, so that the viewing space “A” and the viewing space “B” provide a visible effect. In addition, the shaft 39 is located at an eccentric position deviating from the central point of the viewing space “A” and the viewing space “B”, to provide a different visible effect. Further, the hollow caster structure has a lighter weight by provision of the viewing space “A” and the viewing space “B”, thereby decreasing the material and cost of fabrication. Further, the parts of the hollow caster structure have different and diverse colors which are visible from the viewing space “A” and the viewing space “B”, thereby enhancing the aesthetic quality. Further, the elastic member 23 provides a shock-absorbing function to the hollow caster structure, thereby enhancing the lifetime of the hollow caster structure, and thereby providing a comfortable sensation to the user.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A hollow caster structure comprising:
a base;
a caster body pivotally connected with the base;
a first wheel unit mounted on the caster body; and
a second wheel unit mounted on the caster body;
wherein:
the base is provided with a mounting portion which has interior provided with a through hole;
the caster body is provided with an upright pivotally mounted on a bottom of the mounting portion of the base;
the caster body is provided with a transverse hole;
the first wheel unit includes a first wheel, a first cap mounted on the first wheel, and a second cap mounted on the first wheel;
the first wheel has a first central hole;
the first central hole has a first side provided with a first mounting recess and a second side provided with a second mounting recess;
the first cap is mounted in the first mounting recess;
the first cap has a first viewing hole aligning with the first central hole;
the first cap is provided with a first shaft hole which is located at an eccentric position deviating from a central point of the first viewing hole;
the second cap is mounted in the second mounting recess;
the second cap has a second viewing hole aligning with the first central hole;
the second cap is provided with a second shaft hole which is located at an eccentric position deviating from a central point of the second viewing hole;
the second wheel unit includes a second wheel, a third cap mounted on the second wheel, and a fourth cap mounted on the second wheel;
the second wheel has a second central hole;
the second central hole has a first side provided with a third mounting recess and a second side provided with a fourth mounting recess;
the third cap is mounted in the third mounting recess;
the third cap has a third viewing hole aligning with the second central hole;
the third cap is provided with a third shaft hole which is located at an eccentric position deviating from a central point of the third viewing hole;
the fourth cap is mounted in the fourth mounting recess;
the fourth cap has a fourth viewing hole aligning with the second central hole;
the fourth cap is provided with a fourth shaft hole which is located at an eccentric position deviating from a central point of the fourth viewing hole;
a shaft extends through the fourth shaft hole of the fourth cap, the third shaft hole of the third cap, the transverse hole of the caster body, the second shaft hole of the second cap and the first shaft hole of the first cap; and
a screw member is screwed onto a distal end of the shaft, so that the caster body, the first wheel unit and the second wheel unit are combined together.

2. The hollow caster structure of claim 1, further comprising:
an elastic member mounted in the through hole of the base and biased between the base and the upright of the caster body;
a spindle extending through the through hole of the base, the elastic member and the upright of the caster body; and
a screw element screwed onto a lower end of the spindle and resting on a bottom of the upright.

3. The hollow caster structure of claim 1, wherein the caster body is provided with a first locking piece and a first locking slot, and the second cap is provided with a first retaining piece mounted in the first locking slot of the caster body and a first retaining slot mounted on the first locking piece of the caster body, so that the second cap is affixed to the caster body.

4. The hollow caster structure of claim 3, wherein the caster body is provided with a second locking piece and a second locking slot, and the third cap is provided with a second retaining piece mounted in the second locking slot of the caster body and a second retaining slot mounted on the second locking piece of the caster body, so that the third cap is affixed to the caster body.

5. The hollow caster structure of claim 1, wherein the first cap is provided with a first flange and a first cavity, and the second cap is provided with a first stub closely fitted into the first cavity of the first cap and a first groove closely fitted onto the first flange of the first cap, so that the first cap and the second cap are combined closely.

6. The hollow caster structure of claim 5, wherein the fourth cap is provided with a second flange and a second cavity, and the third cap is provided with a second stub closely fitted into the second cavity of the fourth cap and a second groove closely fitted onto the second flange of the fourth cap, so that the third cap and the fourth cap are combined closely.

7. The hollow caster structure of claim 1, wherein:
the first central hole of the first wheel has an inner peripheral wall provided with a plurality of rolling balls which are arranged in an annular shape and are centered at the first central hole; and
the rolling balls of the first wheel are located between the first cap and the second cap to construct a ball bearing mechanism.

8. The hollow caster structure of claim 1, wherein:
the second central hole of the second wheel has an inner peripheral wall provided with a plurality of rolling balls which are arranged in an annular shape and are centered at the second central hole; and
the rolling balls of the second wheel are located between the third cap and the fourth cap to construct a ball bearing mechanism.

9. The hollow caster structure of claim 1, wherein the first viewing hole of the first cap, the first central hole of the first wheel and the second viewing hole of the second cap form a viewing space which extends through the first wheel.

10. The hollow caster structure of claim 1, wherein the third viewing hole of the third cap, the second central hole of the second wheel and the fourth viewing hole of the fourth cap form a viewing space which extends through the second wheel.
